(19) United States
(12) Patent Application Publication
(10) Pub. No.: US 2026/0147570 A1
(43) Pub. Date: May 28, 2026

(54) Kernel Looping to Eliminate Synchronization Boundaries for Peak Inference Performance in Dataflow Accelerators for Artificial Intelligence AI

(71) Applicant: SambaNova Systems, Inc., Palo Alto, CA (US)

(72) Inventors: David Alan KOEPLINGER, Egg Harbor, NJ (US); Darshan GANDHI, Palo Alto, CA (US); Pushkar Shridhar NANDKAR, Hayward, CA (US); Nathan Francis SHEELEY, Austin, TX (US); Matheen MUSADDIQ, Austin, TX (US); Leon ZHANG, Palo Alto, CA (US); Reid GOODBAR, Palo Alto, CA (US); Matthew SHAFFER, Palo Alto, CA (US); Han Wang, Ann Arbor, MI (US); Angela WANG, Palo Alto, CA (US); Mingran WANG, San Jose, CA (US); Raghu PRABHAKAR, San Jose, CA (US); Peter Buckman, San francisco, CA (US)

(73) Assignee: SambaNova Systems, Inc., Palo Alto, CA (US)

(21) Appl. No.: 19/398,905

(22) Filed: Nov. 24, 2025

Related U.S. Application Data
(60) Provisional application No. 63/723,668, filed on Nov. 22, 2024.

(51) Int. Cl. G06F 9/30; G06F 15/82

(52) U.S. Cl. CPC G06F 9/30065; G06F 15/82

(57) ABSTRACT

A system and method provide kernel looping to eliminate synchronization boundaries to achieve peak inference performance in dataflow accelerators. The system provides a dataflow using a reconfigurable dataflow architecture (RDA) with repeated layered structure having synchronization boundaries between layers for a large language model used in machine learning. The method provides kernel looping between layers by first identifying in the dataflow consecutive calls to a same kernel, wherein the consecutive calls are made in an inference process involving generating a sequence of output tokens based on a given set of input tokens. The method then applies kernel looping to transform the identified consecutive calls in the dataflow into a single call to the kernel. The method further modifies the kernel to contain a pipelined outer loop.

### RELATED APPLICATION

This application claims priority to U.S. Provisional Application No. 63/723,668, filed on Nov. 22, 2024 and titled “Kernel Looping: Eliminating Synchronization Boundaries for Peak Inference Performance,” the contents of which are incorporated by reference herein.

### TECHNICAL FIELD

The present subject matter relates to techniques for improving performance of inference generation in a trained artificial intelligence (AI) model.

### BACKGROUND

Reconfigurable processors, including field programmable gate arrays (FPGAs), can be configured to implement a variety of functions more efficiently or faster than might be achieved using a general-purpose processor executing a computer program. So called Coarse-Grained Reconfigurable Processors (CGRPs) have been developed in which the configurable unit is more complex than used in typical, more fine-grained FPGAs, and may enable faster or more efficient execution of various classes of functions. CGRPs enable implementation of energy-efficient accelerators for machine learning and artificial intelligence (AI) workloads.

Accelerators used in AI also include Graphical Processing Units (GPUs) and Reconfigurable Data Units (RDUs). GPUs, for example those manufactured by Nvidia, are accelerators traditionally used for model training due to their parallel processing power. RDUs are emerging as a more efficient class of architecture for model inference, especially for complex “agentic” workloads. The dataflow architecture of RDUs is designed to handle the massive, power-hungry tasks of inference with lower latency and power consumption by minimizing instruction overheads of traditional processors and providing an efficient memory system for storing intermediate results.

A machine learning inference or training model can be efficiently represented as a dataflow graph in hardware configured into multiple RDUs. The dataflows can be provided to the RDUs and controlled by a host CPU that is interconnected to the RDUs through a network. A dataflow graph is configured by setting configuration bits to different values. The host CPU can include a management controller enabling programming and management of the dataflow throughout a system of interconnected RDUs which includes the CPU sending and controlling of dataflows and distributing configuration files through the RDUs.

A machine learning inference or training model is represented as a dataflow graph provided to one or more RDUs, where dataflows are stored in the RDU's configuration memory to produce a result. The inputs, outputs, and intermediate values of the dataflow graphs are tensors which may be stored individually in separate RDUs or which can be divided into tiles with individual tiles being stored in separate tensors across an AI architecture. It is desirable to improve the performance for both inference and training by controlling the distribution of tensors and the schedule and efficiency of operations of the dataflow in the RDUs.

### SUMMARY

The present disclosure provides a method and system to provide kernel looping to eliminate synchronization boundaries between RDUs to achieve peak inference performance in dataflow accelerators.

Embodiments described herein include a method for providing a dataflow using a reconfigurable dataflow architecture (RDA) with repeated layered structure having synchronization boundaries between layers for a large language model used in machine learning. The method provides kernel looping between layers by first identifying in the dataflow consecutive calls to a same kernel, wherein the consecutive calls are made in an inference process involving generating a sequence of output tokens based on a given set of input tokens. The method then applies kernel looping to transform the identified consecutive calls in the dataflow into a single call to a modified version of the kernel with a pipelined outer loop.

In certain embodiments of the method the step of applying kernel looping includes pattern matching the kernel calls against a compatible contiguous list of kernel calls to identify kernel calls that are compatible to be transformed to provide the single kernel call. The pattern matching is done as a dataflow analysis which determines whether kernel parameters of kernels in the list of kernel calls fit strict patterns of usage across the kernel calls.

In certain embodiments of the method to perform pattern matching, a local property is used to match chained tensors across the kernel calls with a pattern that allows promotion of an intermediate off-chip output tensor to an on-chip buffer with several restrictive conditions. In a first restrictive condition, the patterns are uniquely chained such that the output tensor is only used by the next call. In a further restrictive condition, the patterns are uniquely chained so that the output parameter is consistently used by the same input parameter. In a further restrictive condition, the write address space over all writes entirely covers the read address space to ensure that the read is only dependent on a preceding call.

In certain embodiments of the method, the step of applying kernel looping to transform the identified consecutive calls includes transformation rules applied on the kernel over a list of pattern matched calls. The transformation rules enable creating the transformed kernel with the pipelined outer loop. The number of iterations of kernel calls in the pipelined outer loop is equal to a number of the consecutive kernel calls. The number of consecutive kernel calls under the transformation rules has an outermost dimension created by concatenating and reshaping tensor arguments. A group for the kernel calls is then defined by these reshaped tensor arguments.

Embodiments or a system used by embodiments described herein that is configured with a dataflow using a reconfigurable dataflow architecture (RDA) with repeated layered structure having synchronization boundaries between layers includes a plurality of accelerators which are RDUs. The system further includes a host CPU for providing a dataflow to the plurality of RDUs to configure the RDUs. Further, the system includes a memory for storing the dataflow for providing from the host CPU to configure the RDUs, wherein the dataflow when being provided to the dataflow accelerators operates with method steps described above. These steps include identifying in the dataflow consecutive calls to a same kernel, wherein the consecutive calls are made in an inference process involving generating a sequence of output tokens based on a given set of input tokens. The steps further include applying kernel looping to transform the identified consecutive calls in the dataflow into a single call to the kernel. The steps further include modifying the kernel to contain a pipelined outer loop.

### BRIEF DESCRIPTION OF THE DRAWINGS

The technology disclosed is described with reference to the drawings, in which:

FIG. 1 is a block diagram illustrating an RDU chip architecture system for extending a dataflow through a network between RDUs that provides a system for configuration of a RDUs to provide kernel looping to eliminate synchronization boundaries between the RDUs to achieve peak inference performance.

FIG. 2 shows a subsection of the components of FIG. 1 to illustrate specific components provided for handling the configuration of a dataflow using the host CPU and RDUs.

FIG. 3 shows further details for FIG. 1 that provides network access through an interconnection network to a pool of RDUs (or reconfigurable processors RPs) that can provide for the configuring of a dataflow graph in a machine learning configuration according to the present disclosure.

FIG. 4 provides a Table 1 that shows the operations, bytes, and the operation intensities to generate one token from various Meta Llama 3.1 models provided on H100 systems under different batch sizes and sequence lengths.

FIG. 5 illustrates token generation performance of Llama3.1 on DGX H100 in the first three bars as compared against the SN40L using a dataflow graph including kernel looping of embodiments described herein in the last two bars.

FIG. 6 depicts the structure of Llama3.1 and its execution on both DGX H100 and SN40L without kernel looping embodiments as described herein.

FIG. 7 shows the time breakdown of the Time Per Output Token (TPOT) for Llama3.1-8B on 2, 4, and 8 H100 sockets.

FIG. 8 provides a TPOT breakdown for Llama3.1-8B on a SN40L system.

FIG. 9 provides definitions of kernel pattern usage properties used in kernel pattern matching.

FIG. 10 summarizes transformation rules for kernel looping when optimizing a kernel k over a list of N pattern matched calls.

FIG. 11 provides several examples (a)-(d) of applications of kernel looping.

### DETAILED DESCRIPTION

Embodiments described provide for kernel looping to eliminate synchronization boundaries to achieve peak inference performance in dataflow accelerators for artificial intelligence (AI) applications.

The method and system of the embodiments described herein address the problem of inference performance during token generation which experiences operation at very low peak memory bandwidth due to synchronization overhead at kernel boundaries. A solution to this problem is to provide aggressive fusion of decoder layers into a single kernel, but a problem still exists with this solution because it leaves performance on the table due to synchronization at layer boundaries. A further solution provided by embodiments described herein is to provide kernel looping to eliminate the synchronization boundaries to achieve peak inference performance.

A system providing multiple RDUs with a host CPU support distribution of a dataflow for implementation of embodiments described herein. The system includes multiple RDUs with nodes of a dataflow graph split across the multiple RDUs as controlled by the host CPU. Communication between the RDUs may be achieved using Ethernet DMA (E-DMA) transactions by encapsulating the E-DMA transactions in the Ethernet frame payload. The dataflow instantiated in the RDUs addressed by the present disclosure forms decoder layers in between different RDUs with communication between the different RDUs occurring at kernel boundaries. The synchronization overhead addressed by the present disclosure occurs at these kernel boundaries.

### A. System Description

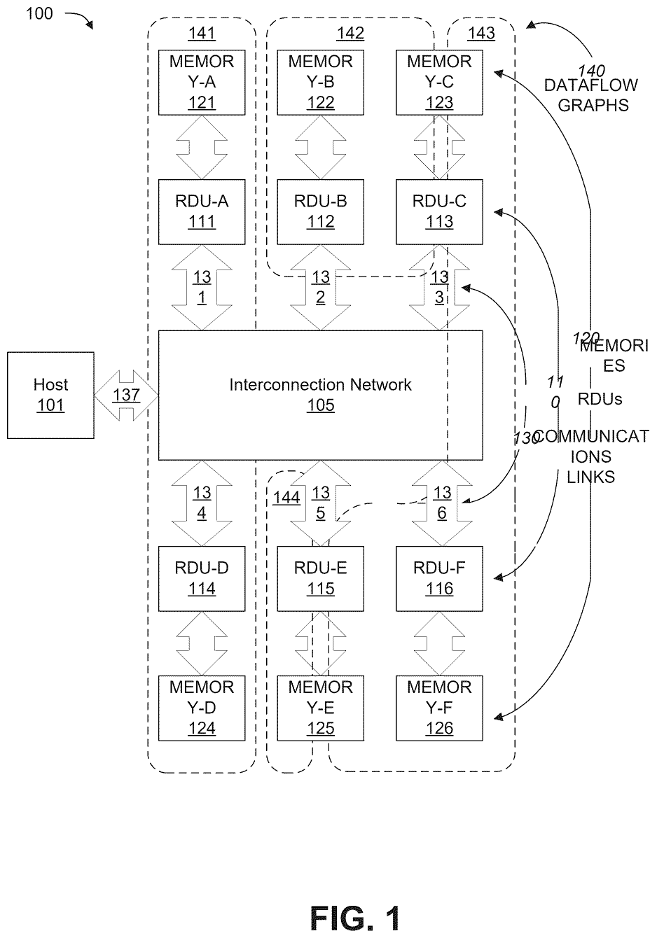

FIG. 1 is a block diagram illustrating a reconfigurable processor chip architecture system for extending a dataflow through a network between accelerators that include RDUs that provide a method and system for configuration of the RDUs to provide kernel looping to eliminate synchronization boundaries between the RDUs to achieve peak inference performance. Although shown to be RDUs, the accelerators can take other forms of reconfigurable processors (RPs) including graphical processing units (GPUs) or coarse grain reconfigurable processors. (CGRPs).

As illustrated, the RDU system 100 includes a host 101, a number of the RDUs (110) including RDUs 111-116, an interconnection network 105 and communication links 130 (131-137) that connect the host 101 and the RDUs 110 to the interconnection network 105. The host CPU 101 runs runtime processes and may also be used to run computer programs, such as a compiler. In some implementations, the compiler may run on a computer separate from host 101. The RDU system 100 may also include memories 120 respectively coupled to the RDUs 110 including memory-A 121 coupled to RDU-A 111, memory-B 122 coupled to RDU-B 112, memory-C 123 coupled to RDU-C 113, memory-D 124 coupled to RDU-D 114, memory-E 125 coupled to RDU-E 115, and memory-F 126 coupled to RDU-F 116. The memories 120 can be any type of memory, including dynamic data rate (DDR) dynamic random-access memory (DRAM), high-bandwidth memory (HBM), static memory, or flash memory.

The communication links 130 can be any type of communication link, parallel or serial, electrical or optical, but in some implementations, each may be one or more physical Ethernet links. The Ethernet links may be compliant with any version of the Ethernet specification. The interconnection network 105 may have any type of topology depending on the system design and particular embodiment. In some implementations, the interconnection network 105 may be implemented as direct links between pairs of devices where each device is one of RDU 111-116 or host 101. For example, the host may have 6 individual links that respectively directly connect to the 6 RDUs 111-116 and each RDU may, in addition to its link connecting to the host 101, have a link to each of the other RDUs 111-116. In that implementation, RDU-A 111 has a first link connecting directly to the host 101, a second link connecting directly to RDU-B 112, a third link connecting directly to RDU-C 113, a fourth link connecting directly to RDU-D 114, a fifth link connecting directly to RDU-E 115, and a sixth link connecting directly to RDU-F 116; so link 131 may include 6 individual links. In other embodiments, the interconnection network 105 may include a bus structure, a switching fabric, or one or more switches and/or routers that are able to route a transaction from an originating RDU 110 or host 101 to a destination RDU 110 or host 101.

Each of the RDUs 110 may include a grid of compute units and memory units interconnected with an internal switching array fabric. The RDUs 110 can be configured by downloading configuration files from the host 101 to configure the RDUs 110 to execute one or more graphs (140), including flow graphs 141-144, that define dataflow computations, and can implement any type of functionality including, but not limited to neural networks. The communication links 130 and the interconnect network 101 provide a high degree of connectivity that can increase the dataflow bandwidth between the RDUs 110 and enable the RDUs 110 to cooperatively process large volumes of data via the dataflow operations specified in the execution graphs 141-144.

A set of flow graphs 141-144 illustrated by dashed lines can be assigned to the RDU system 100 for execution. The graphs 141-144 are overlaid on the block diagram of the RDU system 100 showing how they may be assigned to the RDUs 110. In the example shown, graph1 141 is assigned to RDU-A 111 and RDU-D 114, graph2 142 is assigned to RDU-B 112 and sections of RDU-C 113, graph3 143 is assigned to sections of RDU-C 113, RDU-F 116, and sections of RDU-E 115, while graph4 144 is assigned to sections of RDU-E 115. While the set of graphs 141-144 is statically depicted, one of skill in the art will appreciate that the execution graphs are likely not synchronous (i.e., of the same duration) and that the partitioning within a RDU computing environment will likely be dynamic as execution graphs are completed and replaced.

As can be understood from FIG. 1, nodes of a graph may be distributed across multiple RDUs. Nodes of a graph within a RDU may communicate using internal communication paths of the RDU, but communication between nodes of a single graph in different RDUs may use Ethernet direct memory access (E-DMA) or peer-to-peer (P2P) communication over the links 130 and interconnection network 105.

For example in FIG. 1, a flow graph1 141 is spread across multiple RDUs with RDU-A 111 configured to execute a first node of the graph1 141, and another RDU-D 114 configured to execute a second node of the same graph1 141. The first node of graph1 141 may send data to the second node of graph1 141. For the purposes of this disclosure, in a typical system, a connected processor of host 101 may be used to move the data from the first node to the second node. A RDU system for extending dataflow graphs to memory-to-memory DMA functionality using message-based triggers allows RDU-A 111 to send the data from the first node directly to RDU-D 114 without passing through the host 101.

As mentioned above, the host 101 may configure the RDUs 110 by downloading configuration bit files to the RDUs 110. This may be accomplished by sending the configuration bit files over the communication links 130 and interconnection network 105. The configuration bit files can include information to configure individual units within the RDUs 110 (which are described in more detail below) as well as the internal communication paths between those units. The configuration bit files may be static for the duration of execution of a graph and configure a portion of one of RDUs 111-116 (or the entire RDU) to execute one or more nodes of an execution graph 141-144. Although the detailed description is focused on extending dataflow graphs to memory-to-memory direct memory access (DMA) functionality using message-based triggers, other functionality is envisioned to be covered by the described subject matter. Discussion of extending dataflow graphs to memory-to-memory direct memory access (DMA) functionality using message-based triggers is not intended to limit the detailed description to extending dataflow graphs to memory-to-memory direct memory access (DMA) functionality using message-based triggers or to limit the detailed description in any way.

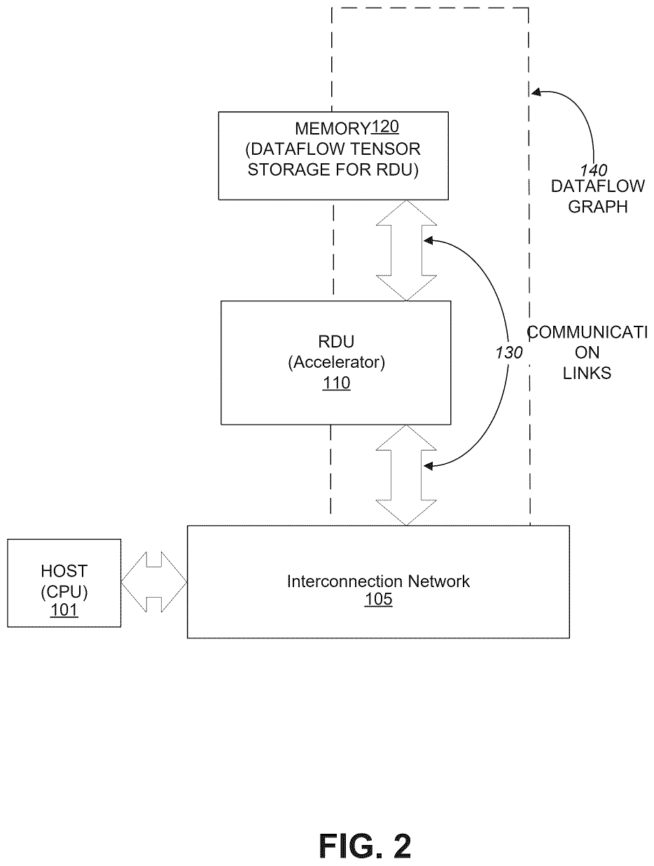

FIG. 2 shows a subsection of the components of FIG. 1 to illustrate specific components provided for handling the configuration of a dataflow using the host CPU and RDUs. FIG. 2 in particular shows that the RDUs 110 can be any accelerator, even though RDUs forming the accelerators can receive the most benefit from embodiments of the present disclosures. For the present disclosure any accelerator can be used handling dataflows which can have a mismatch between tensors in a flowgraph when the tensors are contained in separate RDUs. Further, FIG. 2 shows that the memory 120 provides data storage for the tensors or portions of tensors that can be written into or read from memory 120 handled by the RDUs 110.

As shown in FIG. 2, the hardware used in the dataflow split system includes a pattern compute unit (PCU) 300 that is included in the RDUs 110. The dataflow split hardware also includes pattern memory units (PMUs) 302 provided in memory devices 120. After a data split occurs in the PCUs 300, the output of the PCUs 302 are provided to reorder buffers (ROBs) 304 that are also in the memory device 120. Software and processing for the dataflow split can be handled through the PCU 300 of RDU 110 using the interconnection network 105, communication links 130 and flowgraphs 140.

In particular, with the components of FIG. 2 to accomplish a rearrangement of a tensor in a dataflow that does not have a matching physical representation to a tensor which it is to be routed. The host 101 includes a runtime processor or CPU that manages resource allocation, memory mapping, and execution of the configuration files for applications requesting execution from the CPU that are to be distributed through the interconnect network 105 as flow graphs 140 to the RDUs 110. The host 101 provides the dataflow graph 140 as subdivided into portions to the RDUs 110. The portion going to an individual RDU 110 can be a tensor or even a tile that is a sub-portion of the tensor. The individual RDU 110 can then store and retrieve the dataflow portion to corresponding memory 120 for the RDU 110 over the communications link 130. Retrieving data, such as a tensor, from the RDU 110 to rearrange the tensor so it is compatible with another tensor that originally had a different physical representation can be accomplished by retrieving the data from memory 120 and rewriting the data to memory 120 over the communications link 130 after the tensor is rearranged.

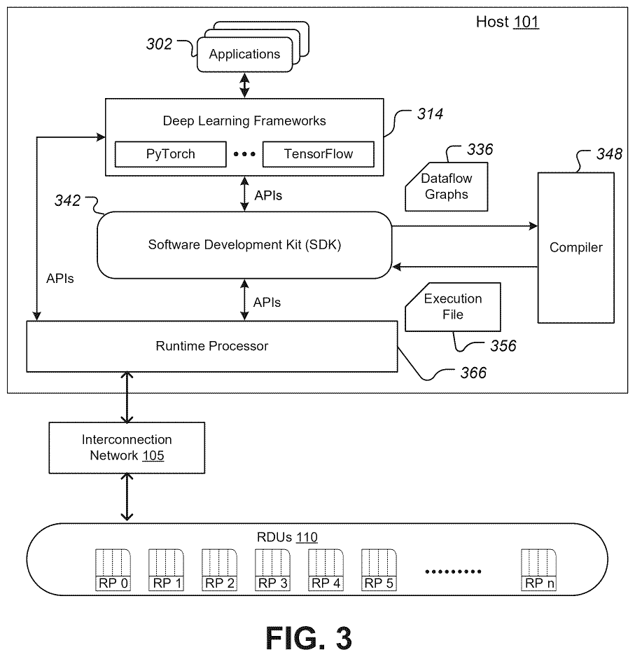

FIG. 3 shows details of the host CPU compute environment 101 of FIG. 1 that provides network access through interconnection network 105 to a pool of RDUs 110 (or reconfigurable processors RP) that can be rapidly configured to instantiate a dataflow graph. The host 101 and RDUs 110 are interconnected by an interconnect network 105 as shown in FIG. 1. The host 101 includes a runtime processor 366 that manages resource allocation, memory mapping, and execution of the configuration files for applications requesting execution from the runtime processor 366 that are distributed as flow graphs to the RDUs 110. The host 101 also provides applications 302 that are to be executed as flow graphs on the RDUs 110 in a distributed fashion by programming the individual compute and memory components to asynchronously receive, process, and send data and control information. In the RDUs 110, computation can be executed as deep, nested dataflow pipelines that exploit nested parallelism and data locality very efficiently. These dataflows contain several stages of computation, where each stage reads data from one or more input buffers with an irregular memory access pattern, performs computations on the data while using one or more internal buffers to store and retrieve intermediate results, and produce outputs that are written to one or more output buffers. The structure of these dataflow pipelines depends on the control and dataflow graph representing the application. Pipelines can be arbitrarily nested and looped within each other.

The applications 302 comprise high-level programs. A high-level program is source code written in programming languages like C, C++, Java, JavaScript, Python, and Spatial, for example, using deep learning frameworks 214 like PyTorch, TensorFlow, ONNX, Caffe, and Keras. The high-level program can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL. In one example, the high-level program can implement a convolutional neural network with several processing layers, such that each processing layer can include one or more nested loops. The high-level program can execute irregular memory operations that involve accessing inputs and weights and performing matrix multiplications between the inputs and the weights. The high-level program can include nested loops with high iteration count and loop bodies that load and multiply input values from a preceding processing layer with weights of a succeeding processing layer to produce an output for the succeeding processing layer. The high-level program can have loop-level parallelism of the outermost loop body, which can be exploited using coarse-grained pipelining. The high-level program can have instruction-level parallelism of the innermost loop body, which can be exploited using loop unrolling, SIMD vectorization, and pipelining.

Regarding loops in the high-level programs of the applications 302, loops directly nested in a loop body are termed the child loops of the outer parent loop. A loop is called an innermost loop if it does not have any children, i.e., there are no nested loops within its body. A loop is an outermost loop if it does not have a parent, i.e., it is not nested within another loop's body. An imperfectly nested loop has a body with a mix of non-looping statements (e.g., primitive arithmetic, logical, and relational operations) and one or more child loops. Parallelism in the imperfectly nested loops can be exploited at any or all loop levels, and in the operations that comprise loop bodies. Parallelism can occur in multiple forms such as fine-grained and coarse-grained pipeline parallelism, data parallelism, and task parallelism.

Software development kit (SDK) 342 generates computation flow graphs (e.g., data flow graphs, control graphs) 336 of the high-level programs of the applications 302. The SDK 342 transforms the input behavioral description of the high-level programs into an intermediate representation such as the dataflow graphs 336. This may include code optimization steps like false data dependency elimination, dead-code elimination, and constant folding. The flow graphs 336 encode the data and control dependencies of the high-level programs.

The flow graphs 336 include nodes and edges. The nodes can represent compute operations and memory allocations. The edges can represent data flow and flow control. In some implementations, each loop in the high-level programs can be represented as a “controller” in the flow graphs 336. The flow graphs 336 support branches, loops, function calls, and other variations of control dependencies. In some implementations, after the flow graphs 336 are generated, additional analyses or optimizations focused on loop transformations can be performed, such as loop unrolling, loop pipelining, loop fission/fusion, and loop tiling.

The SDK 342 also supports programming the reconfigurable processors in the pool of data flow resources 110 at multiple levels, for example, from the high-level deep learning frameworks 314 to C++ and assembly language. In some implementations, the SDK 342 allows programmers to develop code that runs directly on the reconfigurable processors. In other implementations, the SDK 342 provides libraries that contain predefined functions like linear algebra operations, element-wise tensor operations, non-linearities, and reductions required for creating, executing, and profiling the flow graphs 336 on the reconfigurable processors. The SDK 342 communicates with the deep learning frameworks 314 via APIs.

A compiler 348 transforms the flow graphs 336 into a hardware-specific configuration, which is specified in an execution file 356 generated by the compiler 348. In one implementation, the compiler 348 partitions the flow graphs 336 into memory allocations and execution fragments, and these partitions are specified in the execution file 356. Execution fragments represent operations on data. An execution fragment can comprise portions of a program representing an amount of work. An execution fragment can comprise computations encompassed by a set of loops, a set of graph nodes, or some other unit of work that requires synchronization. An execution fragment can comprise a fixed or variable amount of work, as needed by the program. Different ones of the execution fragments can contain different amounts of computation. Execution fragments can represent parallel patterns or portions of parallel patterns and are executable asynchronously.

In some implementations, the partitioning of the flow graphs 336 into the execution fragments includes treating calculations within at least one innermost loop of a nested loop of the flow graphs 336 as a separate execution fragment. In other implementations, the partitioning of the flow graphs 336 into the execution fragments includes treating calculations of an outer loop around the innermost loop of the flow graphs 336 as a separate execution fragment. In the case of imperfectly nested loops, operations within a loop body up to the beginning of a nested loop within that loop body are grouped together as a separate execution fragment.

Memory allocations represent the creation of logical memory spaces in on-chip and/or off-chip memories for data required to implement the flow graphs 336, and these memory allocations are specified in the execution file 356. Memory allocations define the type and the number of hardware resources (functional units, storage, or connectivity components). Main memory (e.g., DRAM) is off-chip memory for which the memory allocations can be made. Scratchpad memory (e.g., SRAM) is on-chip memory for which the memory allocations can be made. Other memory types for which the memory allocations can be made for various access patterns and layouts include read-only lookup-tables (LUTs), fixed size queues (e.g., FIFOs), and register files.

The compiler 348 binds memory allocations to virtual memory units and binds execution fragments to virtual compute units, and these bindings are specified in the execution file 356. In some implementations, the compiler 348 partitions execution fragments into memory fragments and compute fragments, and these partitions are specified in the execution file 356. A memory fragment comprises address calculations leading up to a memory access. A compute fragment comprises all other operations in the parent execution fragment. In one implementation, each execution fragment is broken up into a plurality of memory fragments and exactly one compute fragment. In one implementation, the compiler 348 performs the partitioning using reverse dataflow analysis such that inputs to an address used in a memory access are recursively flagged until the compiler 348 reaches either constant values or (bound) loop/pattern iterators. A single execution fragment can produce one or more memory fragments, depending on how many memory accesses exist in the original loop body. In cases where the same memory addressing logic is shared across multiple memory accesses, address calculation may be duplicated to create multiple memory fragments from the same execution fragment.

The memory fragments of the execution fragments are configured to index into data structures. At least one of the memory fragments indexes into a data structure in the logical memory spaces of one of the memory allocations. Each compute and memory fragment preserves information about all loops whose loop bodies directly contain the operations in the corresponding execution fragment. In one implementation, this corresponds to replicating the calculation of the loop iterators of each loop into each compute and memory fragment. This replication allows each fragment to preserve the same iterative behavior as the original program while also allowing distributed calculation of loop iterators.

The compiler 348 assigns the memory fragments to the virtual memory units and assigns the compute fragments to the virtual compute units, and these assignments are specified in the execution file 356. Each memory fragment is mapped operation-wise to the virtual memory unit corresponding to the memory being accessed. Each operation is lowered to its corresponding configuration intermediate representation for that virtual memory unit. Each compute fragment is mapped operation-wise to a newly allocated virtual compute unit. Each operation is lowered to its corresponding configuration intermediate representation for that virtual compute unit.

The compiler 348 allocates the virtual memory units to physical memory units of an RDU 110 (or RP) and allocates the virtual compute units to physical compute units of the RDU, and these allocations are specified in the execution file 356. The compiler 348 places the physical memory units and the physical compute units onto positions in an array of configurable units of the RDU and routes data and control networks between the placed positions, and these placements and routes are specified in the execution file 356. In one implementation, this includes allocating physical resources such as counters and registers within each physical memory and compute unit, and these allocations are specified in the execution file 356.

The compiler 348 translates the applications 302 developed with commonly used open-source packages such as Keras and PyTorch into reconfigurable processor specifications. The compiler 348 generates the configuration files with configuration data for the placed positions and the routed data and control networks. In one implementation, this includes assigning coordinates and communication resources of the physical memory and compute units by placing and routing units onto the array of the processor while maximizing bandwidth and minimizing latency.

For a more detailed explanation of a distribution of a dataflow graph, tensors and tiles throughout a system of RDUs the following explanation is provided. A dataflow graph is a visual representation of a computation, where nodes represent operations (like addition, multiplication, or matrix operations) and edges which are tensors represent the data that flows between these operations. Essentially, the graph defines the flow of data through a series of computations, with tensors acting as the conduits for data passing between operations.

Tensors are fundamental data structures in a dataflow graph, acting as the containers for the data that flows between operations. They are multi-dimensional arrays, generalizing scalars, vectors, and matrices. The dataflow graph provides a structure for organizing and visualizing the flow of tensors through the series of operations.

In the context of machine learning, especially when dealing with large models and distributed computing, a tensor is related to a shard as a whole to its parts. The tensor is a multi-dimensional array used to represent data in neural networks. Sharding is a technique used to divide the large tensor into smaller pieces, or shards, for distribution and processing across multiple RDUs in a distributed RDU system when a tensor is too large for an RDU. Each RDU upon subdivision of a tensor into tiles will hold a single shard.

The dataflow graph can include multiple tensors. For one tensor to route data to another tensor, the tensors are set to have the same logical shape. For example to be routed together, the output/input pair should be tensors of the same dimensions (e.g., they should both be 16×1024×128 tensors). A compiler when defining a dataflow will route tensors so that when they connect to provide data they will have the same shape.

Dataflow graph compilers are typically provided in the host CPU to create the dataflow graph which routes tensors in individual RDUs when each RDU holds a separate tensor or a portion of a tensor. Dataflow compilers can include PyTorch or other software that apply operations to configure the tensors and provide routing for each tensor in an RDU.

### B. Kernel Looping Description

The present disclosure provides kernel looping to eliminate synchronization boundaries between RDUs to achieve peak inference performance. An RDU system providing such kernel looping is described to follow.

### Overview

Token generation speed as part of the inference process is critical to power the next wave of AI inference applications. GPUs significantly underperform during token generation due to synchronization overheads at kernel boundaries, utilizing only a small percentage of their peak memory bandwidth. While recent dataflow architectures mitigate these overheads by enabling aggressive fusion of decoder layers into a single kernel, some performance is left on the table due to synchronization penalties at layer boundaries.

This disclosure describes kernel looping, a specialized global optimization technique which exploits an optimization opportunity brought by combining the unique layer-level fusion that fuses decoder layers into a single kernel as possible in modern dataflow architectures with the repeated layer structure found in language models that provides for kernel looping. Kernel looping eliminates synchronization costs between consecutive calls to the same kernel by transforming these calls into a single call to a modified kernel containing a pipelined outer loop.

This disclosure includes a first example of kernel looping on a dataflow accelerator model for AI that uses RDUs. The dataflow accelerator used is the SambaNova SN40L. Experimental results from the dataflow accelerator demonstrate that kernel looping according to embodiments described herein speeds up the decode phase of a wide array of powerful open-source models by as much as 2.2 times. Kernel looping as described herein further allows scaling of decode performance over multiple interconnected dataflow accelerator systems sockets, achieving speedups of up to 2.5 times. Kernel looping as described herein enables the first accelerator system to achieve over 90% of peak performance with utilization of 8 and 16 sockets to achieve a speedup of up to 3.7 times over a previous accelerator system not using the kernel looping.

### 1. Introduction

In recent years, the landscape of open-source language models has evolved significantly, with state-of-the-art models becoming smaller while achieving very high accuracy. These compact models, often pretrained or distilled from larger ones over vast datasets, have achieved remarkable accuracy through advancements in model architecture and training techniques. As model context length continues to grow (sometimes exceeding 128,000 tokens), more sophisticated prompt engineering and in-context learning techniques have emerged, shifting focus from training to inference.

Inference involves generating a sequence of output tokens, given a sequence of input tokens. Output tokens are generated in two distinct phases: “prefill” and “decode”. Prefill is the process of producing the first output token, while decode is the process of producing all subsequent output tokens in an autoregressive manner. The time spent in the prefill phase is called Time to First Token (TTFT). The time taken to produce one token in the decode phase is called Time per Output Token (TPOT). Decoding performance is often reported as a throughput: tokens per second. The prefill phase is often compute-bound on modern AI accelerators due to the high operational intensity in its compute graph. Conversely, the decode phase is memory-bound due to low operational intensity. The ratio of input: output tokens also varies widely based on the task. For instance, summarization tasks have a high input: output token ratio, while math and coding questions can have a low input: output token ratio.

With access to powerful open-source models, the machine learning community has produced advanced inference techniques that drastically increase the number of output tokens for an input prompt. Chain-of-Thought (CoT) prompting performs complex reasoning tasks by breaking down problems into a series of logical steps. However, this method generates multiple intermediate tokens during inference, significantly increasing the overall time spent in the decode phase. Similarly, test-time scaling techniques have demonstrated that inference efficiency can be improved by increasing the output tokens generated, leveraging the model's ability to iterate and refine its outputs. Such iterative methods rely on a large context window that holds all tokens generated at each step. While a naive deployment of such solutions can negatively impact time to first token (TTFT), innovations like context caching mitigate this impact by preserving KV cache values across multiple turns. Context caching accelerates prefill by reducing the compute required during this phase in multi-turn conversations. With context caching, optimization needs shift back to the decode phase. This brings optimizations like speculative decoding to the forefront. Speculative decoding relies on smaller draft models to have high decode throughput to be effective. This way, the smaller model generates tokens rapidly which are then checked and corrected by a larger model at a chosen cadence. Consequently, fast token generation on both large and small models is the most important enabler for modern inference.

The decode phase of inference is memory-bound on modern AI accelerators like the Nvidia DGX H100, referred to herein as the DGX H100 or H100, due to its low operational intensity. The Meta Llama 3.1, referred to herein as Llama 3.1, provides software for dataflow graph configuration that can be used on the H100 and does not include kernel looping as disclosed herein. Llama 3.1 is bandwidth-bound. Both the H100 and Llama 3.1 will be used to provide experimental performance parameters relative to the SN40-L using software for dataflow configuration that includes kernel looping as described herein.

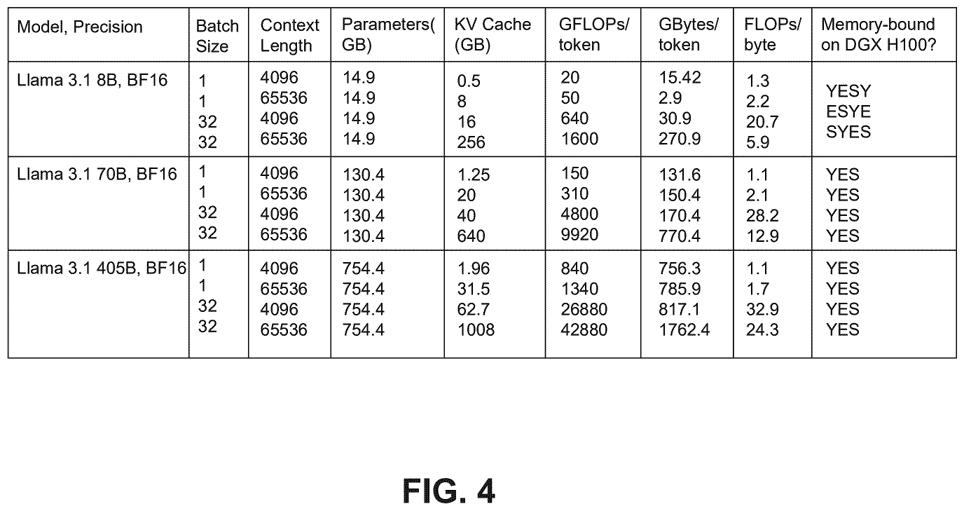

FIG. 4 provides a Table 1, labeled Table 1 (400), that shows the operations, bytes, and the operation intensities to generate one token from various Meta Llama 3.1 models provided on H100 systems under different batch sizes and sequence lengths. Table 1 shows that Llama 3.1 is bandwidth-bound on the H100. In fact, any operation intensity less than 333 is memory bandwidth-bound on DGX H100. In Table 1, an estimate is made of the FLOPs/byte by assuming that generating a single token requires reading all parameters and KV cache values once. The reported compute FLOPs are obtained by adding all matrix multiply operations in all layers. Streaming operations like softmax account for a much smaller fraction of the compute and do not change the overall insight below. DGX H100 has a peak BF16/FP16 compute capability of 1000 TFLOPs (excluding structured sparsity), and a peak HBM bandwidth of 3 TB/s. Any configuration with an operation intensity less than 1000/3=333 will therefore be memory bandwidth-bound. As shown in Table 1, all Llama 3.1 model configurations are memory bandwidth-bound. Note that for the combination of large sequence length and large batch size, the FLOPs/byte goes down as sequence length increases. Unlike batch size, which linearly increases both compute FLOPs and KV cache size, sequence length only impacts a subset of the operators during decode. Consequently, the KV cache size grows faster than the compute FLOPS, leading to lower operational intensity.

Batching is a common technique to increase operation intensity and improve the overall Performance/TCO. However, batch sizes cannot be made arbitrarily large. Both prefill TFLOPs (which is already compute-bound) and KV cache size increase linearly with batch size. Consequently, higher batch sizes increase TTFT which impacts the end-user SLA and interactivity. Larger KV cache sizes can exceed the limited HBM capacity available on accelerators. Finally, the number of output tokens produced can widely vary for each query in the batch. This variability in output tokens can utilize hardware inefficiently and increase overall queuing delays. As a result, many inference applications, such as chatbots or LLM agents, often limit batch size to ensure a reasonable turnaround time for user queries.

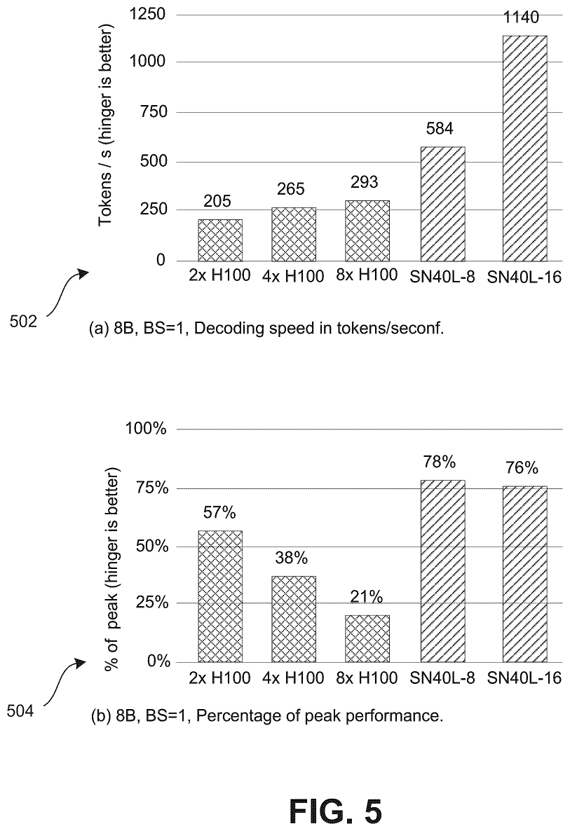

FIG. 5 illustrates token generation performance of Llama3.1 on DGX H100 in the first three bars as compared against the SN40L using a dataflow graph including kernel looping of embodiments described herein in the last two bars. FIG. 5 plots the decode speed for each. Synchronization overheads at kernel call boundaries in DGX H100 inhibit utilizing HBM bandwidth efficiently. The last two bars, in comparison, show the significant contribution of embodiments described herein to alleviate the overhead shown in the first two bars. Kernel looping mitigates these overheads on SN40L shown by the last two bars.

FIG. 5 includes a part a, plot labeled 502, showing tokens vs. decoding speed in tokens per second. FIG. 5 includes a part b, a plot labeled 504, showing a plot of percentage of peak vs. percentage of peak performance, where a value of 100% corresponds to the performance obtained if the available HBM bandwidth were fully utilized to transfer weights and the KV cache from memory, with everything else happening in its shadow. With the plots in parts a and b, one can observe that GPUs operate well below their roofline performance for decode. Furthermore, decode performance scales poorly with increasing numbers of GPUs. Much of this inefficiency stems from forced synchronization overheads at kernel call boundaries. Rigidity in the GPU's on-chip memory and interconnect, limited on-chip SRAM, and programming model constraints limit the number of operators that can be fused and executed asynchronously in a kernel.

Reconfigurable Dataflow Architectures (RDAs) have recently emerged as promising commercial alternatives to GPUs. Dataflow architectures provide a much more flexible hardware substrate that enables “layer-level fusion”, or fusing entire layers into a single kernel call, significantly reducing the number of kernel calls compared to GPUs. However, we quantify and argue that dataflow architectures incur synchronization overheads at kernel call boundaries too. Furthermore, synchronization costs can be nontrivial: reprogramming a dataflow architecture at kernel boundaries involves loading a new configuration bitstream onto all on-chip units, which is a heavier operation than a typical instruction fetch. These synchronization overheads can quickly wipe out the performance upside from higher operator fusion. Note that synchronization points at kernel call boundaries are not fundamental to the algorithm itself. Rather, it is imposed by the limitations of the underlying hardware platform and/or programming model.

This disclosure proposes a compiler optimization to eliminate unnecessary synchronization boundaries. The compiler provides a dataflow graph building on the benefits of layer-level fusion in dataflow architectures and exploits repetitive layers found in the most powerful model architectures to date. Kernel looping applies a global optimization technique that rewrites groups of repeated kernel calls into a single kernel call with a pipelined outer loop. Kernel looping has two key benefits: (i) eliminating synchronization between calls to the same kernel, and (ii) overlapping the compute and communication across kernels.

Plots of performance parameters, such as shown in FIG. 5, provide an evaluation of benefits of kernel looping on the SambaNova SN40L Reconfigurable Dataflow Unit (RDU), a commercial RDA amenable to aggressive layer-level fusion. FIG. 5 shows that with kernel looping, Llama3.1 8B can run at 78% of roofline performance on the SN40L, outperforming DGXH100 by two times. Kernel looping also helps scale performance across more SN40L sockets, achieving 76% of roofline performance on 16 sockets.

### 2. Decoder Performance Characterization

In this Section 2, a detailed performance characterization of token generation using the DGX H100 is provided to show that that H100 with GPUs operates under 25% of its peak roofline performance, largely due to synchronization overheads at kernel call boundaries. Further, Section 2 further shows that synchronization overheads on dataflow architectures using SN40L account for 30% of overall token generation time when using Llama3.1 and can wash away the benefits of layer-level fusion without kernel looping provided in accordance with embodiments described herein. This information is used to describe an optimization opportunity exposed by layer-level fusion wherein kernel looping can be used to mitigate these overheads.

In this section 2, Llama3.1 is used as the dataflow generator software as a driving example to characterize token generation performance on two platforms: the H100 and the SN40L. Here, SN40L-8 corresponds to a system with 8 SN40L sockets, similar to DGX H100 with 8 GPUs. Specifically, we highlight and quantify the inefficiencies on both platforms due to synchronization at kernel call boundaries, thus motivating the need for the kernel looping techniques described herein. We chose Llama3.1-8B because it is a very popular open-source model. But more importantly, Llama3.1-8B plays an important role as a draft model to accelerate larger models like Llama3.1-70B and Llama3.1-405B using speculative decoding. While we use a specific model to illustrate concepts, the insights apply broadly to a larger variety of model architectures.

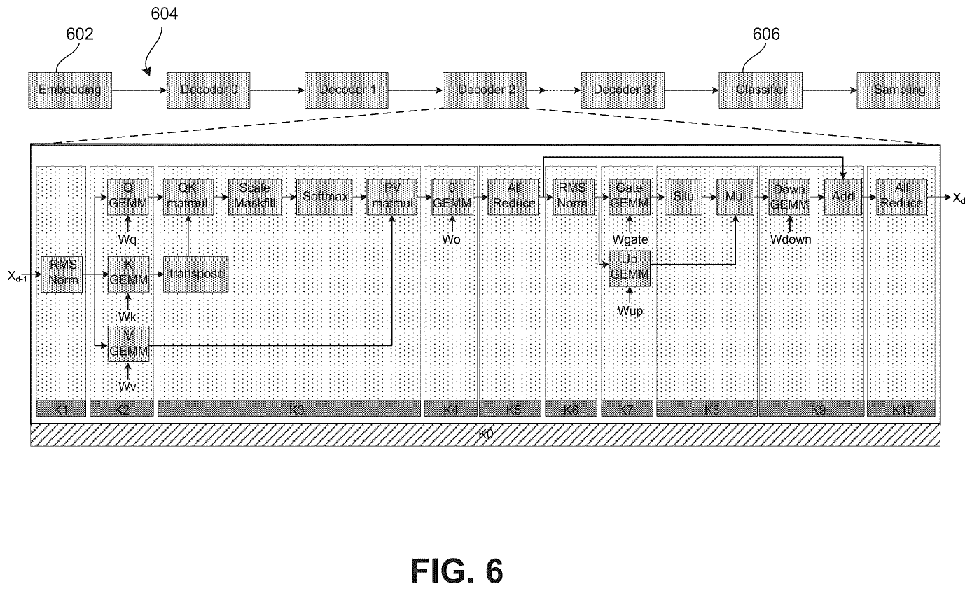

FIG. 6 depicts the structure of Llama3.1 and its execution on both DGX H100 and SN40L without kernel looping embodiments as described herein. FIG. 6 includes Llama3.1 with 32 decoder layers, and the operators within one decoder layer. Labels K1-K10 are kernel calls on the DGX H100, obtained by profiling the execution of Llama3.1-8B using TensorRT-LLM with the NVIDIA Nsight profiler. Label K0 (orange) corresponds to one kernel call on SN40L for the entire decoder layer. Collective communication operations like allreduce do not execute asynchronously with other operators on the DGX H100. On SN40L, allreduce is pipelined and overlapped with other operators. FIG. 6 shows that Llama3.1 has 4 major types of blocks: one Embedding layer 602, 32 Decoder layers 604, one Classifier layer 606, and Sampling 608. While Sampling is not part of the model, we include it as it is executed once for every output token, similar to the other layers. FIG. 6 also shows the key operators making up a decoder. As decoder layers dominate token generation time, the rest of this section will focus on how a single decoder layer is executed on multiple sockets.

Each decoder layer is parallelized across multiple sockets to extract higher performance. In a DGX H100, a decoder is parallelized across 8 H100 GPUs. While several parallelization strategies exist in literature, the parallelition used herein is Tensor-Parallel (TP) mapping as it is a commonly deployed mechanism. TP mapping involves sharding weights and input tensors along one or more dimensions and distributing each shard to a different socket. Sharding introduces distributed reduction and broadcast operations across sockets like allreduce.

FIG. 6 shows the execution of a decoder on DGX H100 and SN40L-8. On both platforms, a “kernel” is a unit of work dispatched to the accelerator, which executes one or more operators in a fused fashion. Kernels act as forced synchronization barriers on both platforms. Specifically, operators belonging to different kernels are not executed asynchronously. For a TP-mapped kernel, a kernel call boundary executes an implicit synchronization barrier across all sockets. The key difference between the two platforms is the number of operators fused into a single kernel call. On H100, a decoder is broken up and executed as 10 kernel calls, labeled in green in FIG. 6 as K1 through K10. In contrast, the SN40L-8 executes all operators in the decoder layer as a single kernel call, labeled in orange in FIG. 6 as K0.

The kernel makeup for H100 is obtained by using TensorRTLLM to run Llama3.1 and by extracting kernel call information using the NVIDIA Nsight Systems profiler. The kernel makeup on the SN40L-8 is similar to prior literature performing layer-level fusion. Collective communication operators introduced by TP mapping like allreduce are shown explicitly as a separate operator in FIG. 6. On H100, allreduce is implemented by calling into the NVIDIA Collective Communications Library. On the SN40L, allreduce is implemented as a cross-chip dataflow operator using the chip-to-chip peer-to-peer (P2P) protocol. We first characterize the performance of a decoder layer on DGX H100. Profiling data is obtained using benchmarking scripts included with TensorRT-LLM after a few warm up iterations, as recommended by the documentation. Using this methodology, we observe that Llama3.1-8B generates tokens at over 300 tokens/s on 8×H100. This is competitive with the optimized implementations of several commercial API providers, suggesting that our methodology is representative of a real world deployment that includes key GPU optimizations.

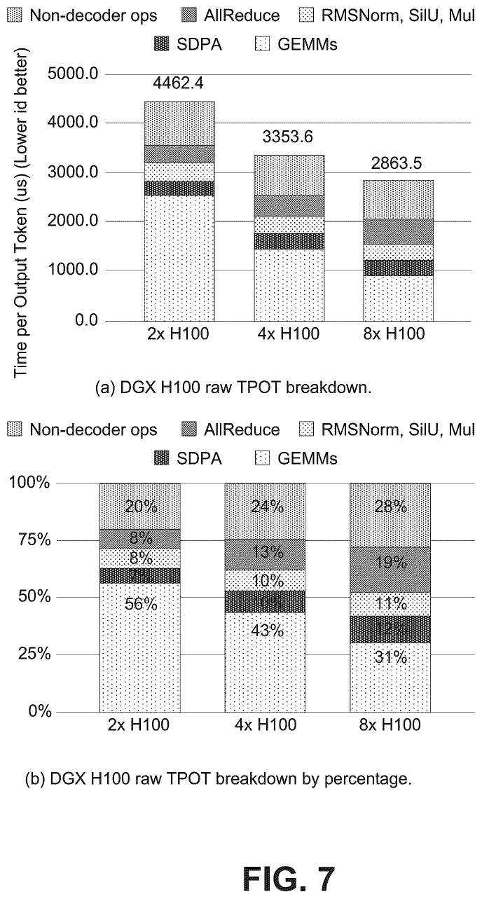

FIG. 7 shows the time breakdown of the Time Per Output Token (TPOT) for Llama3.1-8B on 2, 4, and 8 H100 sockets. All kernels studied in this scenario are memory bandwidth bound. From FIG. 5 it can be seen that the performance of all kernels does not scale by the same amount with increasing socket count. GEMM performance scales better than other operators, but not linearly. Operators like RMSNorm, SiLU, and SDPA perform at a significantly lower efficiency from their theoretical peak despite having more aggregate HBM bandwidth, indicating that kernel warm up and synchronization costs inhibit scaling. The cost of allreduce and other non-decoder operators account for a larger portion of the overall time per output token for 8×H100.

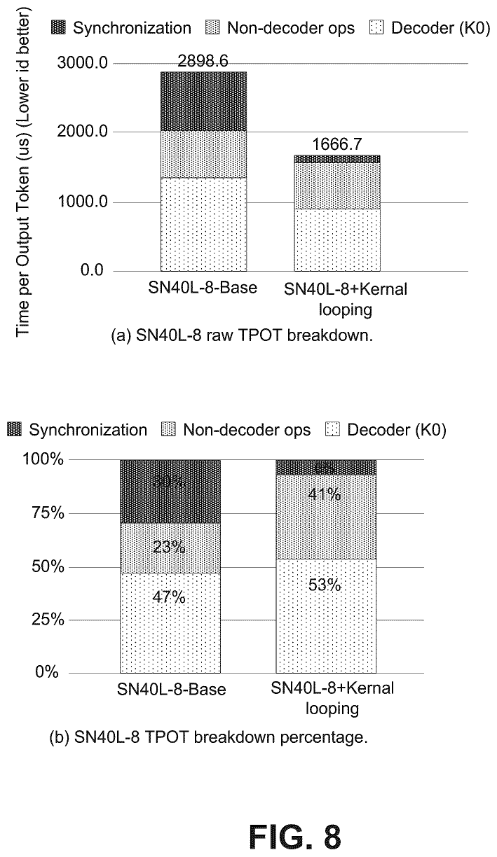

Next characterized is the mapping and performance of a decoder layer on SN40L with a single kernel used to produce one output token. Unlike H100, SN40L invokes a single kernel K0 to execute a decoder. This speaks to a well-studied advantage of dataflow architectures over more traditional data-parallel mappings: the number of operations that can be fused into a single kernel is very flexible. On one extreme, a single logical operation can be spread across the entire chip using data parallelism. On the other extreme, hundreds of operations can be fused into a single kernel via aggressive tiling and pipelining transformations. This characteristic of dataflow architectures, and SN40L in particular, makes aggressive kernel fusion applicable across a wide range of model sizes and complexities. By reducing the number of kernel calls, the single decoder mapping reduces the number of synchronization required. However, FIG. 8 shows that a single decoder kernel by itself is insufficient to extract peak performance on SN40L. Synchronization overheads at the end of each call to K0 account for more than 30% of the TPOT, nullifying the performance upside of layer fusion. In particular, FIG. 8 provides a Time-per-Output-Token (TPOT) breakdown for Llama3.1-8B on a SN40L system. Synchronization overheads washes out the performance upside with a single kernel decoder. The kernel looping described herein significantly reduces synchronization overheads to give close to peak TPOT.

However, a single decoder kernel exposes an optimization ‘opportunity to the compiler: the same kernel is called repeatedly in a chained fashion, where the output of a previous call feeds the input of the next call. The repetition stems from the repetitive layer structure inherent in Transformer model architectures, which form the backbone of the most powerful text and multi-modal models in the community today. We therefore propose a generic compiler transformation to rewrite a sequence of such repetitive kernel calls in a schedule into a single kernel call.

FIG. 6 shows the impact of this transformation on the kernel call schedule. All 32 calls to K0 are combined into a single call: all_decoders_nosync (x_in). FIG. 8 shows that this transformation reduces the synchronization cost by almost 8 times. However, there is also a bigger, more profound impact with this transformation: kernel warmup cost is only paid once at the beginning of the first decoder. HBM bandwidth stays continuously utilized to stream weights and KV caches in dataflow fashion, fully overlapping it with compute and allreduce. Consequently, Llama3.1-8B token generation can achieve 78% of the peak roofline performance with SN40L-8, and scales well to SN40L-16 with 76% of roofline performance as shown in FIG. 5.

### 3. System Overview

In this section 3, implementation details of the kernel looping optimization are described and several simplified examples to help explain its behavior are provided.

### 3.1 Pattern Matching

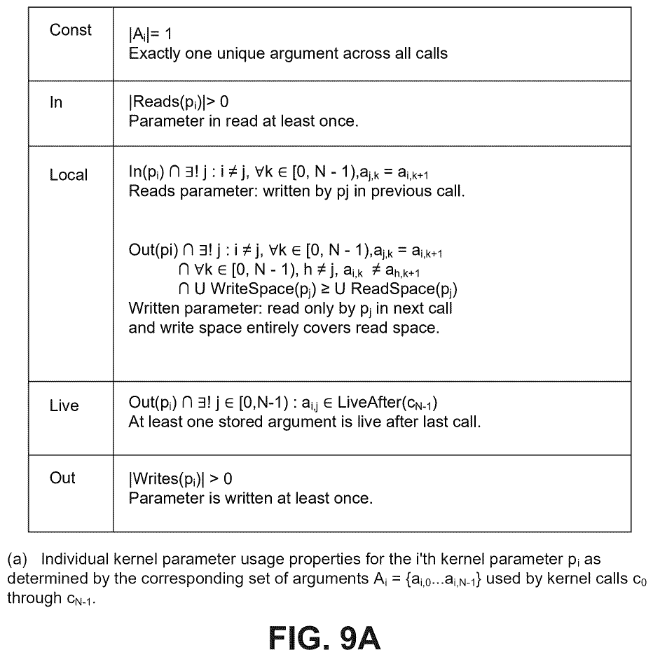

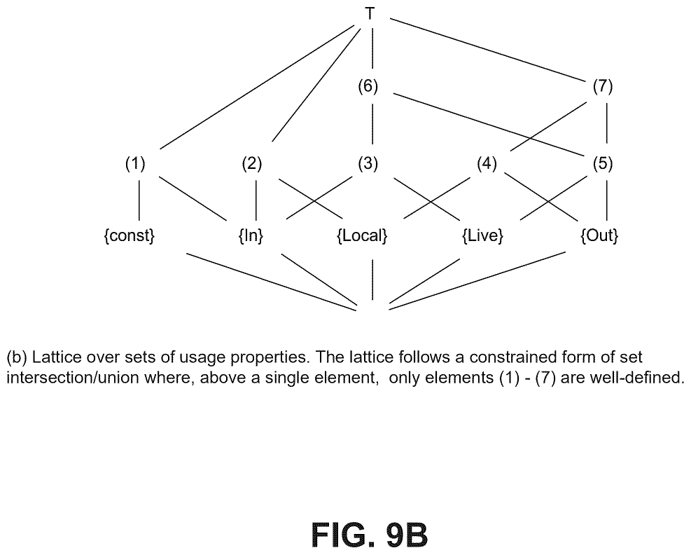

The first step in kernel looping is to pattern match against a compatible contiguous list of kernel calls. This is done as a dataflow analysis which determines whether all kernel parameters fit strict patterns of usage across these calls. Given a kernel with M parameters [p0, . . . , pM−1], a candidate set of N calls to this kernel C=[c0, . . . , cN−1], where arguments to the i′th parameter pi are Ai=[ai, 0, . . . , ai, N−1], relevant usage properties are defined in FIG. 9. In particular, FIG. 9 provides definitions of kernel pattern usage properties used in kernel pattern matching. It is assumed basic usage analysis (Reads, Writes) has been run within the kernel body and that a basic liveness analysis (LiveAfter) has already been run across kernel calls.

The Local property is used to match on chained calls. As discussed subsequently, this pattern can be used to promote intermediate off-chip tensors to an on-chip buffer. However, doing so requires that several restrictive conditions are met. First, the parameters must be uniquely chained. That is, within C, the chained output tensor must only be used by the next call, and the output parameter must be consistently used by the same input parameter. Additionally, the write address space (WriteSpace) over all writes must entirely cover the read address space (ReadSpace) to ensure that the read is only dependent on the preceding call. (Note that depending on the level of abstraction used by the intermediate representation, proving this condition in general may require polyhedral analysis of access patterns. A compiler using a sufficiently high level domain specific intermediate representation of tensor operations, however, can match on common cases with relative ease.)

$$P ( p ) = Const ( p ) ∨ In ( p ) ∨ Local ( p ) ∨ Live ( p ) ∨ Out ( p ) \qquad ( Equation 1 )$$

Equation 1 defines the set of usage properties P for a parameter p. In this equation, the function F (p) yields the singleton usage property set {F} if the corresponding condition in FIG. 6a holds and Ø otherwise. The meet function V is defined by the lattice in FIG. 6b. The candidate call list C then pattern matches successfully if Equation 2 holds:

$$Match ( C ) = ∀ i ∈ [ 0 , M ) : P ( pi ) < T \qquad ( Equation 2 )$$

We require that P (p) is strictly less than the top element (T), as the top element is considered to be a match failure. All other elements in the lattice are successful matches.

The matching function in Equation 2 can be used to build an analysis over all kernel calls in the program. A basic greedy algorithm can be sufficient to fuse and pipeline chains of decoder calls in the targeted language models. In applications with more complex kernel call interactions and orderings, it may be necessary to do a cost-driven search to maximize the number of optimized contiguous calls.

### 3.2 Transformation

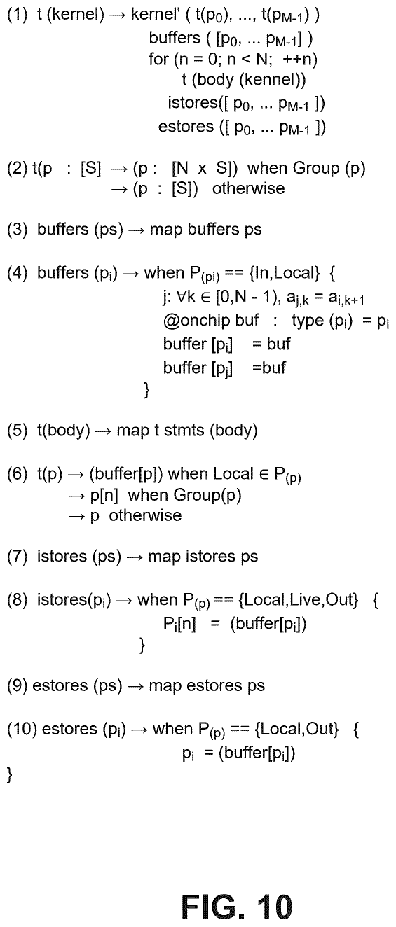

FIG. 10 summarizes transformation rules for kernel looping when optimizing a kernel k over a list of N pattern matched calls. The expression p: [S] represents a typed kernel parameter where the tensor shape S is encoded in the type system. As shown in rule 10(1), this transformation creates a new kernel with a loop, where the number of iterations is equal to the number of calls being optimized.

In order to use this loop to iterate over arguments across calls, one can view the number of calls N as a new, outermost dimension created by concatenating and reshaping the tensor arguments. This is referred to as “grouping”, where arguments to a parameter should become a group if Equation 3 holds. Correspondingly, rule 10(2) alters parameter shapes, assumed here to be encoded in the type system.

$$Group ( p ) = Live ∈ P ( p ) ⋃ ( Local / ∈ P ( p ) ⋂ Const / ∈ P ( p ) ) \qquad ( Equation 3 )$$

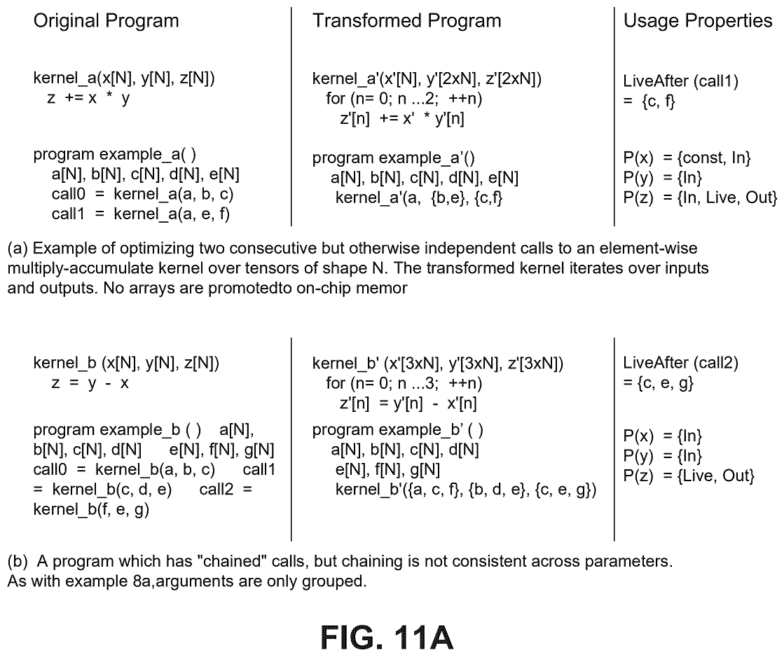

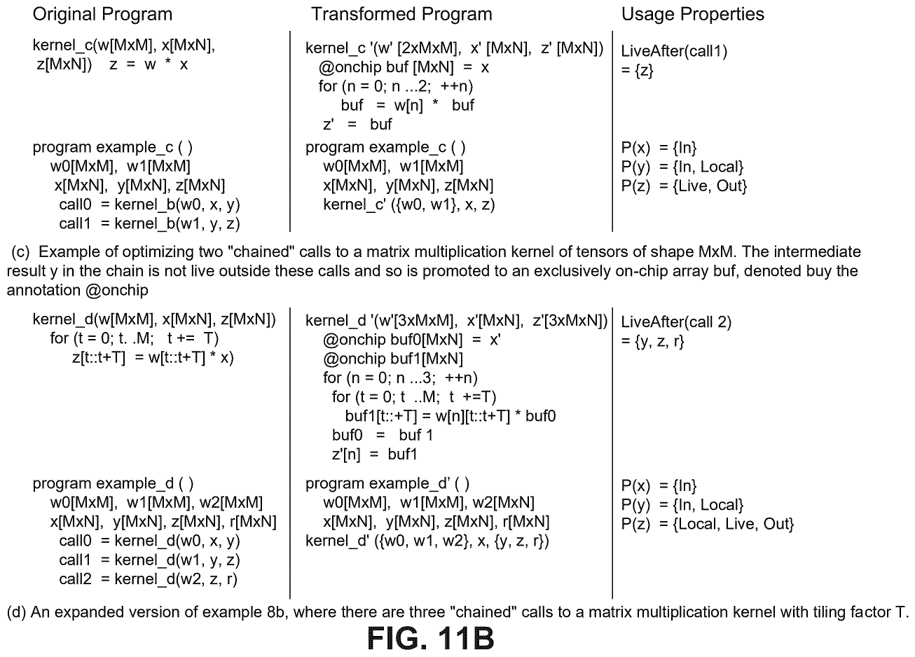

Due to their chained nature, Local kernel parameters are always found in pairs: an input (read) parameter pi and an output (written) parameter pj. In rule 10(3-4), each pair of Local parameters introduces a memory allocation initialized by the read parameter, pi. This memory is used as a buffer to store intermediate results across outer loop iterations. Note that double buffering may be required to prevent write after read hazards. For brevity, details of detecting this case are elided from FIG. 10, but transformation with double buffering details can be found in FIG. 11.

In rule 10(4), we unconditionally use the @onchip annotation to note that the memory is to be allocated in on-chip accelerator memory, not main memory. In practice, a compiler would likely wish to consult performance and memory capacity models to determine whether this array can or should be in on-chip memory.

The body of the loop introduced in rule 10(1) is then generated by transforming each statement in the original kernel body via rule 10(5). Rule 10(6) alters any reference to a grouped parameter to index into its outer dimension at outer loop iterator n. For example, a reference to parameter p becomes p[n], p[i] becomes p[n] [i], and so on. Likewise, a reference to a Local parameter becomes a reference to the associated on-chip memory created by rule 10(4). Uses of Const parameters are unchanged, though later compiler passes may choose to cache data rather than rereading it from off-chip memory.

Lastly, using rules 10(7-10), on-chip memories are stored back to their associated output parameter. If the output parameter is Live, the store occurs at the end of each iteration of the introduced loop. Otherwise, it occurs once at the end of the transformed kernel.

Outside of the kernel, the calls in C are collapsed to a single call. The arguments to this merged call are such that Const parameters use their single, unique argument, {Local, In} parameters receive the first argument, and {Local, Out} parameters receive only the last argument. Each grouped parameter pi, including {Local, Live, Out}, receives a grouping of all arguments to that parameter, expressed as {ai, 0 . . . ai, N−1}.

Grouping can be implemented as a “ragged” array of pointers, where corresponding loads and stores jump to different tensor offset addresses with each value of loop iterator n. As an optimization, if the compiler has direct control over tensor addresses in main memory, grouped tensors can be organized such that they are linear in memory to maximize spatial locality. However, such groupings cannot be done if the same tensor would appear in multiple disjoint groups.

### 3.3 Examples of Kernel Looping

FIG. 11 provides several examples (a)-(d) of applications of kernel looping. In example 11a, kernel looping is applied to two consecutive but independent (unchained) calls to a kernel performing an element-wise multiply-accumulate. The first kernel parameter x has the same argument a for both calls, so it remains unchanged. Later compiler optimizations may choose to cache this tensor on-chip or re-load it from off-chip memory on each iteration. Arguments to parameters y and z differ across iterations but are entirely independent, so the corresponding arguments for these parameters are grouped and iterated over in the loop introduced in kernel_a’.

Example 11b shows an example of a program where calls are not independent: one call's result is input to the following call. However, no parameters meet the criteria for the Local property. Between the first two calls, the result written from parameter z is used as an input to parameter x. But in the last two calls, z is used as an input to y. As a result, arguments are only grouped, like in example 11a. Note that in this case, tensors c and e appear in multiple argument groups.

In example 11c, the program has two “chained” calls to a matrix multiplication kernel, where the result of one call is used as an input to the next call. Since the intermediate tensor y is not used except in the second call, this chaining is promoted to exclusively on-chip memory buffer. This memory is initialized with the first argument to parameter x, used to store intermediate results, and then used to write the final result to parameter z at the end of the kernel. Parameter w is transformed using the same mechanism as in example 11a, where all arguments are grouped and iterated over.

Example 11d expands on example 11c: the matrix multiplication is now tiled on one dimension and all intermediate results are live after the last targeted call. As before, kernel looping introduces an on-chip memory to host the chained intermediate result. However, buf0 is reread while the next iteration is being produced, meaning the on-chip buffer needs to be double buffered. Additionally, since all intermediate results are live, the write to z occurs at the end of every outermost iteration rather than at the end of the entire kernel.

### 4 Conclusion

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

1. A method of providing a dataflow using a reconfigurable dataflow architecture (RDA) with repeated layered structure having synchronization boundaries between layers for a large language model used in machine learning for artificial intelligence (AI) comprising:
identifying in the dataflow consecutive calls to a same kernel, wherein the consecutive calls are made in an inference process involving generating a sequence of output tokens based on a given set of input tokens;
applying kernel looping to transform the identified consecutive calls in the dataflow into a single call to the kernel; and
modifying the kernel to contain a pipelined outer loop.

2-4. (canceled)

5. The method of claim 1,
wherein the step of applying kernel looping to transform the identified consecutive calls includes transformation rules applied on the kernel,
wherein the transformation rules are used to create the transformed kernel with the pipelined outer loop, and
wherein a number of iterations in the pipelined outer loop is equal to a number of the consecutive kernel calls.

6. The method of claim 5,
wherein the number of consecutive kernel calls has an outermost dimension created by concatenating and reshaping tensor arguments.

7. The method of claim 6,
wherein a grouping is provided by the transform wherein the reshaped tensor arguments become the group.

8. An apparatus that can be configured with a dataflow using a reconfigurable dataflow architecture (RDA) with repeated layered structure having synchronization boundaries between layers for a large language model used in machine learning for artificial intelligence (AI), the apparatus comprising:
a plurality of dataflow accelerators;
a host CPU for providing a dataflow to the plurality of accelerators to configure the accelerators; and
a memory for storing the dataflow for providing from the host CPU to configure the dataflow accelerators, wherein the dataflow when being provided to the dataflow accelerators operates with steps including:
identifying in the dataflow consecutive calls to a same kernel, wherein the consecutive calls are made in an inference process involving generating a sequence of output tokens based on a given set of input tokens;
applying kernel looping to transform the identified consecutive calls in the dataflow into a single call to the kernel; and
modifying the kernel to contain a pipelined outer loop.

9. The apparatus of claim 8, wherein the dataflow accelerators are reconfigurable dataflow units (RDUs).

10. The apparatus of claim 8,
wherein the step of applying kernel looping to transform the identified consecutive calls includes transformation rules applied on the kernel,
wherein the transformation rules are used to create the transformed kernel with the pipelined outer loop, and
wherein a number of iterations in the pipelined outer loop is equal to a number of the consecutive kernel calls.

11. The apparatus of claim 10,
wherein the number of consecutive kernel calls has an outermost dimension created by concatenating and reshaping tensor arguments.

12. The apparatus of claim 11,
wherein a grouping is provided by the transform wherein the reshaped tensor arguments become the group.

13. A non-transitory computer readable medium comprising stored instructions, which when executed by a processor, causes the processor to control circuitry to provide a dataflow using a reconfigurable dataflow architecture (RDA) with repeated layered structure having synchronization boundaries between layers for a large language model used in machine learning for artificial intelligence (AI) comprising:
identifying in the dataflow consecutive calls to a same kernel, wherein the consecutive calls are made in an inference process involving generating a sequence of output tokens based on a given set of input tokens;
applying kernel looping to transform the identified consecutive calls in the dataflow into a single call to the kernel; and
modifying the kernel to contain a pipelined outer loop.

14. The non-transitory computer readable medium of claim 13,
wherein the step of applying kernel looping to transform the identified consecutive calls includes transformation rules applied on the kernel,
wherein the transformation rules are used to create the transformed kernel with the pipelined outer loop, and
wherein a number of iterations in the pipelined outer loop is equal to a number of the consecutive kernel calls.

15. The method of claim 14,
wherein the number of consecutive kernel calls has an outermost dimension created by concatenating and reshaping tensor arguments.

16. The method of claim 15,
wherein a grouping is provided by the transform wherein the reshaped tensor arguments become the group.
